(19) United States
(12) Patent Application Publication
(10) Pub. No.: US 2018/0092136 A1
(43) Pub. Date: Mar. 29, 2018

(54) INFORMATION PROCESSING DEVICE, METHOD FOR CONTROLLING INFORMATION PROCESSING DEVICE, AND CONTROL DEVICE

(71) Applicant: SHARP KABUSHIKI KAISHA, Sakai City, Osaka (JP)

(72) Inventors: NAOKI SHIOBARA, Sakai City (JP); MASAFUMI UENO, Sakai City (JP)

(21) Appl. No.: 15/573,738

(22) PCT Filed: Mar. 15, 2016
(86) PCT No.: PCT/JP2016/058113

§ 371 Date: Nov. 13, 2017

(30) Foreign Application Priority Data
May 15, 2015 (JP) 2015-100400

(51) Int. Cl. H04B 5/00; H04W 4/00; G06F 3/046; G06F 3/14

(52) U.S. Cl. CPC H04W 76/02; H04W 4/008; G06F 2203/04101; H04B 5/0075; G06F 3/14; G06F 3/046

(57) ABSTRACT

Near Field Communication is established while a touch panel is in use. In a mobile terminal (1), an NFC antenna (60) is disposed at a position overlapping a touch panel (50). The mobile terminal (1) includes a communication availability determination unit (15) configured to determine whether an NFC tag (160) available for Near Field Communication with the NFC tag (160) is in contact with or in proximity to the touch panel (50), and an antenna control unit (16) configured to bring the NFC antenna (60) the Near Field Communication into a state where the Near Field Communication is enabled in a case that the communication availability determination unit (15) determines that the NFC tag (160) is in contact with or in proximity to the touch panel (50).

### TECHNICAL FIELD

The present invention relates to an information processing device.

### BACKGROUND ART

In recent years, electronic devices having a touch panel or a touch sensor as an input device (for example, mobile terminals or the like) have been commonly used. More recently, Near Field Communication (NFC) technology using a Radio Frequency Identification (RFID) tag or the like has been actively developed.

For example, PTL 1 discloses a system for integrating a touch sensor and a REID tag reader. In the system disclosed in PTL 1, a RFID tag reader (circuitry for detecting and reading an RFID tag) is not used for sensing the proximity of a RFID tag to this system, but a low power consumption touch sensor is used.

In other words, as a power consumption reduction measure, the touch sensor, which is low in power consumption compared with the RFID tag reader, is incorporated in the system disclosed in PTL 1. Thus, the system disclosed in PTL 1 is directed for power saving of this system.

### CITATION LIST

### Patent Literature

PTL 1: JP 2013-239164 A (published on Nov. 28, 2013)

### SUMMARY OF INVENTION

### Technical Problem

However, in PTL 1, the technical concept of establishing Near Field Communication while a touch sensor (or a touch panel) is in use (i.e., concurrent use of the touch sensor and the Near Field Communication) has not been considered.

For example, in the system disclosed in PTL 1, in order to prevent the operation of the RFID tag reader from adversely affecting the touch sensor, the operation of the touch sensor is deactivated while the RFID tag reader reads data from the RFID tag (i.e., while Near Field Communication is established between the RFID tag reader and the RFID tag).

Thus, the invention disclosed in PTL 1 has a problem that the establishment of Near Field Communication is not allowed while the touch panel is in use.

The invention has been made to solve the above-described problem, and an object of the invention is to provide an information processing device able to establish Near Field Communication while a touch panel is in use.

### Solution to Problem

In order to solve the above-described problem, an information processing device according to one aspect of the invention includes: a touch panel configured to sense contact or proximity of a terminal device, a communication section disposed at a position overlapping the touch panel and configured to establish Near Field Communication with the terminal device, a communication availability determination unit configured to determine whether the terminal device able to establish Near Field Communication with the communication unit is in contact with or in proximity to the touch panel, and a communication section control unit configured to bring the communication section into a state where the communication section is able to establish Near Field Communication in a case that the communication availability determination unit determines that the terminal device is in contact with or in proximity to the touch panel.

In order to solve the above-described problem, a control method for controlling an information processing device according to one aspect of the invention is a method for controlling an information processing device including a touch panel configured to sense contact or proximity of a terminal device, and a communication section disposed at a position overlapping the touch panel and configured to establish Near Field Communication with the terminal device. The method includes a communication availability determination step for determining whether the terminal device able to establish Near Field Communication with the communication unit is in contact with or in proximity to the touch panel, and a communication section control step for bringing the communication section into a state where the communication section is able to establish Near Field Communication in a case that the terminal device is determined to be in contact with or in proximity to the touch panel.

In order to solve the above-described problem, a control device according to one aspect of the invention is a control device of an information processing device including a touch panel configured to sense contact or proximity of a terminal device, and a communication section disposed at a position overlapping the touch panel and configured to establish Near Field Communication with the terminal device. The control device includes: a communication availability determination unit configured to determine whether the terminal device able to establish Near Field Communication is in contact with or in proximity to the touch panel, and a communication section control unit configured to bring the communication section into a state where the communication section is able to establish Near Field Communication in a case that the communication availability determination unit determines that the terminal device is in a state in contact with or in proximity' to the touch panel.

### Advantageous Effects of Invention

The information processing device according to one aspect of the invention produces an advantageous effect which enables Near Field Communication to be established while the touch panel is in use.

The method for controlling the information processing device according to one aspect of the invention or the control device of the information processing device also produces substantially the same advantageous effect.

### BRIEF DESCRIPTION OF DRAWINGS

FIG. 1 is a functional block diagram illustrating a configuration of essential components of an information processing system according to a first embodiment of the present invention.

FIG. 2 is a perspective view illustrating an overview of operations of an NFC antenna and an NFC tag in the first embodiment of the invention.

FIG. 3A is an exploded perspective view and FIG. 3B is a perspective view, illustrating a schematic structure of a touch panel in the first embodiment of the invention.

FIG. 4 is a diagram illustrating the positional relationship between the NFC antenna and the touch panel in the first embodiment of the invention.

FIG. 5A is a perspective view and FIG. 5B is a top view, illustrating a graph representing, on an xy-plane, a distribution of capacitance generated on the touch panel with contact of the NFC tag in the first embodiment of the invention.

FIG. 6 is a diagram illustrating one example of an induced electromotive force table in the first embodiment of the invention.

FIGS. 7A and 7B are diagrams each illustrating a distance between the center points of two planes parallel to each other,

FIGS. 8A and 8B are diagrams each provided for explaining operations of an antenna control unit in the first embodiment of the invention.

FIG. 9 is a diagram illustrating an example of a processing flow of Near Field Communication in a mobile terminal according to the first embodiment of the invention.

FIG. 10 is a functional block diagram illustrating a configuration of essential components of an information processing communication system according to a second embodiment of the invention.

FIGS. 11A 11B are diagrams each provided for explaining operations of an antenna control unit in the second embodiment of the invention.

FIG. 12 is a diagram illustrating an example of a processing flow of Near Field Communication in a mobile terminal according to the second embodiment of the invention.

FIG. 13 is a diagram illustrating an information processing device according to a modification of the invention,

### DESCRIPTION OF EMBODIMENTS

### First Embodiment

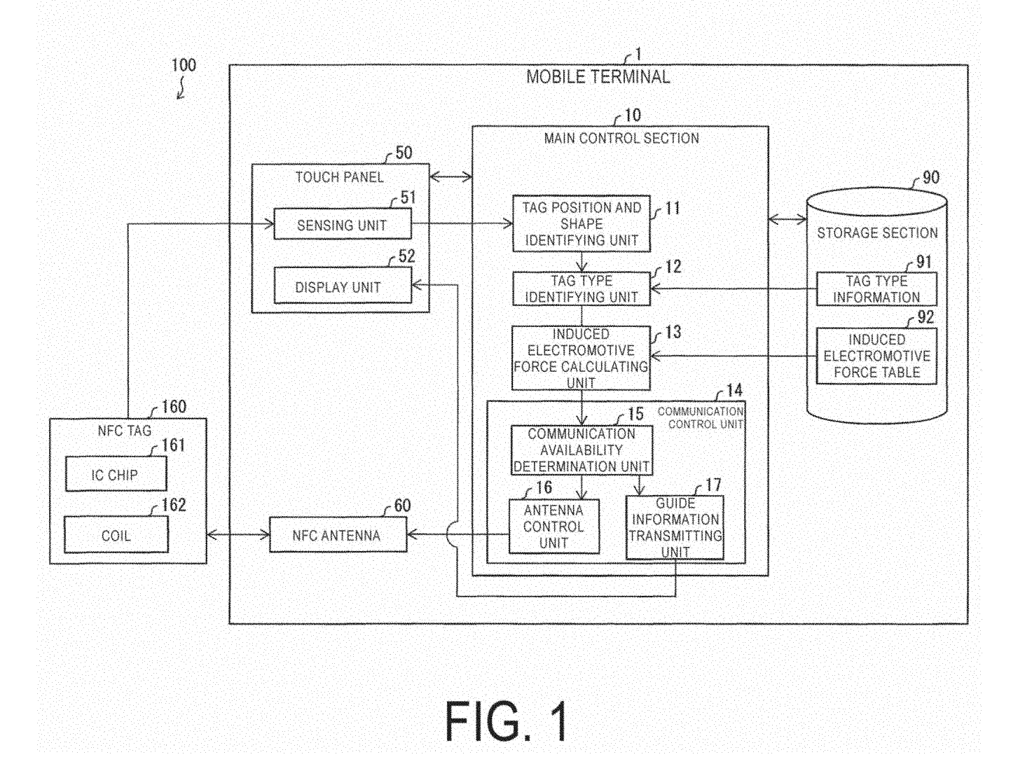

Hereinafter, a first embodiment of the invention will be described with reference to FIGS. 1 to 9.

### Overview of Information Processing System 100

FIG. 1 is a functional block diagram illustrating a configuration of essential components of an information processing system 100 according to the first embodiment. As illustrated in FIG. 1, the information processing system. 100 includes a mobile terminal 1 (information processing device) and an NFC tag 160 (terminal device). In the information processing system 100, Near Field Communication is established between the mobile terminal 1 and the NFC tag 160.

The mobile terminal 1 is provided with a touch panel 50 and an NFC antenna 60 (communication section). As described below, the mobile terminal 1 of the embodiment is configured to establish Near Field Communication via the NIT antenna 60 while using the touch panel 50.

Note that, as described below, the touch panel 50 serves as, for example, a capacitive touch panel. However, the touch panel 50 need not necessarily be limited to only such a capacitive touch panel. For example, an electromagnetic induction touch panel may be used as the touch panel 50.

### Overview of Operations of NFC Antenna 60 and NFC Tag 160

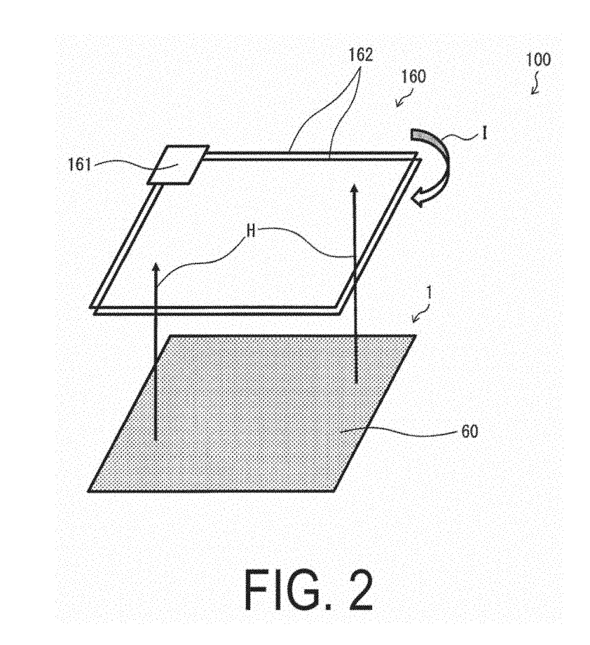

First, an overview of operations of the NFC antenna 60 and the NFC tag 160 will be described with reference to FIG. 2. FIG. 2 is a perspective view illustrating the overview of operations of the NFC antenna 60 and the NFC tag 160. As illustrated in FIG. 2, the NFC tag 160 includes an IC chip 161 and a coil 162.

The NFC antenna 60 is a component provided on the mobile terminal 1 to establish Near Field Communication with the NFC tag 160. Power to operate the NFC antenna 60 is supplied from a battery (not illustrated) of the mobile terminal 1. In the following, Near Field Communication between the NFC tag 160 and the NFC antenna 60 will described with examples.

The NFC antenna 60 performs polling to detect whether a target NFC tag 160 for Near Field Communication is located in proximity' to the NFC antenna. 60. As used herein, the term “potting” is an operation of periodically changing the magnitude of a radio signal (i.e. a magnetic field H) emitted from the NFC antenna 60.

In a case that the NFC tag 160 is brought sufficiently close to the NFC antenna 60, the magnetic field H emitted from the NFC antenna 60 is interlinked with the coil 162. As such, electromagnetic induction accompanying a temporal change of the magnetic field H causes a current i (i.e., an induced current) in the coil 162. This current i flows in the IC chip 161.

The IC chip 161 is an IC chip on which various components for establishing Near Field Communication are integrated. Note that the IC chip 161 is provided with an antenna for transmitting a radio signal to the NFC antenna 60. This configuration allows various information to be transmitted from the IC chip 161 to the NFC antenna 60 (in other words, from the NFC tag 160 to the mobile terminal 1) via the radio signal.

In a case that the NFC tag 160 serves as a passive tag, the current i is used as power to activate the IC chip 161. That is, the IC chip 161 is activated by the current i. Furthermore, the current i is also used as power required for communications between the IC chip 161 and the NFC antenna 60.

In contrast, in a case that the NFC tag 160 serves as an active tab, a power source for supplying power to activate the IC chip 161 is provided inside the IC chip 161. In the case of the active tab, the above-described current i is only used as power required for communications between the IC chip 161 and the NFC antenna 60.

An induced electromotive force V generated in the coil 162 accompanying the electromagnetic induction is represented by Expression 1 below:

V=−N×(Δφ/Δt) (1)

In Expression 1, N denotes the number of turns in the coil 162, and Δt denotes an arbitrary micro time. In addition, Δφ denotes a variation in magnetic flux interlinked with the coil 162 during the micro time Δt. The term (Δφ/Δt) in the right side of Expression 1 may be understood as a variation in magnetic flux interlinked with the coil 162 per unit time.

As the induced electromotive force V in Expression 1 increases, the current i generated by electromagnetic induction also increases. To properly establish Near Field Communication between the NFC antenna 60 and the NFC tag 160, the current i of some degree of magnitude needs to be generated. Thus, to properly establish Near Field Communication between the NFC antenna 60 and the NFC tag 160, the induced electromotive force V of some degree of magnitude needs to be generated.

### Schematic Structure of Touch Panel 50

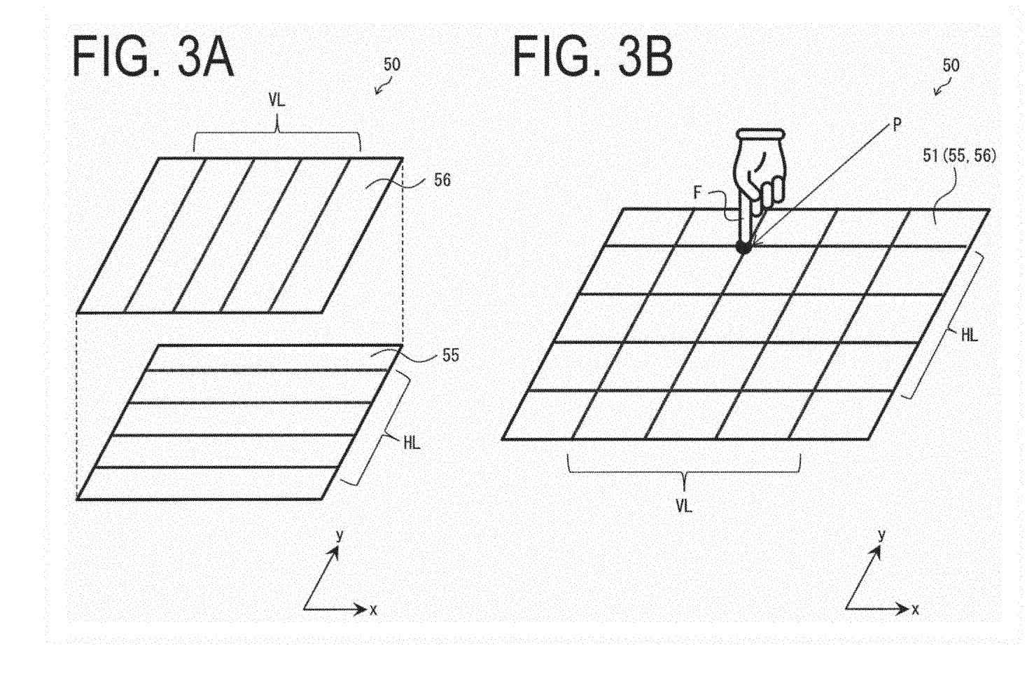

Subsequently, a schematic structure of the touch panel 50 will be described with reference to FIGS. 3A and 3B. FIG. 3A is an exploded perspective view and FIG. 3B is a perspective view, illustrating the schematic structure of the touch panel 50.

As illustrated in FIG. 3A, the touch panel 50 includes a first electrode layer 55 and a second electrode layer 56. The first electrode layer 55 and the second electrode layer 56 are layers on which a first electrode HL and a second electrode VL (described below) are provided, respectively.

As illustrated in FIG. 3B, in the touch panel 50, the first electrode layer 55 is placed on the second electrode layer 56, so that an input face (a sensing unit 51 in FIG. 1) is provided.

More specifically, the first electrode layer 55 is covered with a transparent protection film (not illustrated) formed of glass or the like. Thus, the surface of the protection film serves as the input face of the touch panel 50. Furthermore, the second electrode layer 56 is placed on the display face (the display unit 52 in FIG. 1) of the touch panel 50. The display unit 52 may be a liquid crystal display.

Accordingly, the touch panel 50 in which the input face and the display face are integrally provided can be achieved, for example, by forming the first electrode layer 55 and the second electrode layer 56 as transparent layers. By way of example, the first electrode layer 55 and the second electrode layer 56 may be formed of Indium Tin Oxide (IOT).

However, for the touch panel 50 according to one aspect of the invention, the display unit 52 (display face) is not an essential component. In other words, the touch panel 50 according to one aspect of the invention has only to include the sensing unit 51 (input face).

Furthermore, for the information processing device according to one aspect of the invention, the display unit 52 (display device) is also not an essential component. As described below, a component other than the display unit 52 (for example, a speaker) may be used as an informing unit for informing a user that the NFC tag 160 has to be moved from its current position in order to enable Near Field Communication between the NFC antenna 60 and the NFC tag 160. An example of using a speaker as the informing unit will be described in the section of Third Embodiment (described below). Note that the informing unit may be omitted.

For the information processing device according to one aspect of the invention, an example in which no display unit 52 (display device) is provided will be described below with reference to FIG, 13. For the information processing device according one aspect of the invention, even when the display unit 52 is provided, the display unit 52 may be provided outside the touch panel 50.

The capacitive touch panel, in which the two panels, (i) the first electrode layer 55 for providing the first electrode HL and (ii) the second electrode layer 56 for providing the second electrode HL, are stacked one on another as in the touch panel 50 of the embodiment, is also referred to as a projected-capacitive touch panel.

As illustrated in FIG. 3A, the first electrode HL is an electrode arranged extending in a predetermined direction on the first electrode layer 55. In the following, the direction parallel to the first electrode layer HL is referred to as the “x-direction”. The x-direction may be also referred to as the “horizontal direction of the touch panel 50”. At least one first electrode FEL may be provided on the first electrode layer 55.

The second electrode VL is an electrode arranged extending in a specific direction that is different from the x-direction described above, on the second electrode layer 56. In the following, the direction parallel to the second electrode layer VL is referred to as the “y-direction”. The y-direction may be, for example, the direction perpendicular to the x-direction described above. In this case, the y-direction may be referred to as the “vertical direction of the touch panel 50”. At least one second electrode VL may be provided on the second electrode layer 56.

In the touch panel 50 of the embodiment, the first electrode HI may serve as a drive electrode (also referred to as a “drive line”), and the second electrode VL may serve as a sense electrode (also referred to as a “sense line”). Alternatively, the first electrode HL may serve as a sense electrode, and the second electrode VL may serve as a drive electrode. Similar to the first electrode layer 55 and the second electrode layer 56 described above, the first electrode layer HL and the second electrode layer VL may be also formed of ITO, for example.

In the touch panel 50, when a drive voltage is applied to the first electrode HL, capacitance is formed at each intersection point of the first electrode HL and the second electrode VL. The capacitance distribution of the intersection points is calculated from a sensing signal (voltage signal) that is read from the second electrode VL.

Consider a case in which a user's finger F touches the input face of the touch panel 50 at a point P as illustrated in FIG. 3B. In this case, the touch of the user's finger F changes the distribution of capacitance formed at each intersection point on the touch panel 50.

The touch panel 50 is able to determine the position of the point P touched by the finger F by analyzing the capacitance distribution. Furthermore, the touch panel 50 is able to determine the position of the point P approached by the finger F based on the capacitance distribution. Thus, the touch panel 50 is able to determine the position of the point touched or approached by the finger F.

An object which the touch panel 50 is able to sense (through touch sensing or proximity sensing) is not limited to the finger F. The object may be any object that will cause a relatively large change in capacitance distribution on the touch panel 50 as the object touches or approaches the touch panel 50. Thus, it is understood that the object may be any object with a relatively high conductivity.

For example, the NFC tag 160 has a relatively high permittivity because metal is contained therein as described below. This configuration enables the touch panel 50 to properly sense contact or proximity of the NFC tag 160.

### Structure of Mobile Terminal 1

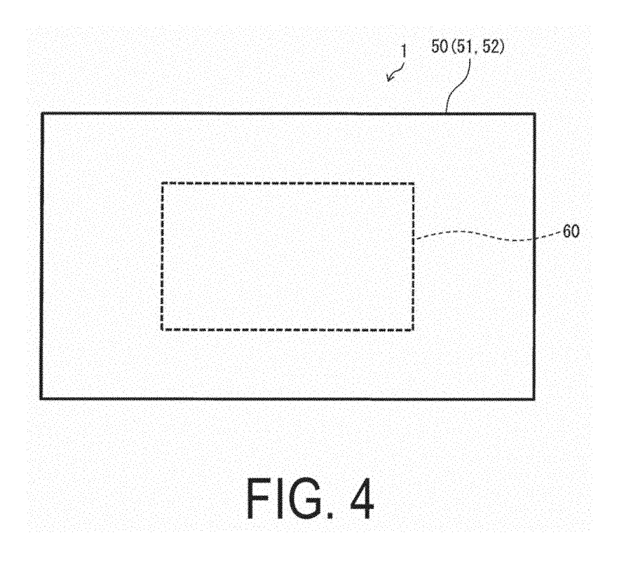

Next, the structure of the mobile terminal 1 will be described in detail with reference to FIG. 4 to FIG. 9, in addition to FIG. 1. As illustrated in FIG. 1, the mobile terminal I includes a main control section 10 (control device), the touch panel 50, the NFC antenna 60, and a storage section 90.

The main control section 10 comprehensively controls operations of the mobile terminal 1. A Central Processing Unit (CPU) executes programs stored in the storage section 90, so that functionality of the main control section 10 is provided. The storage section 90 serves as a storage device for storing various programs executed by the main control section 10 and data used by the programs.

The main control section 10 includes a tag position and shape identifying unit 11 (shape identifying unit), a tag type identifying unit 12 (type identifying unit), an induced electromotive force calculating unit 13, and a communication control unit 14. The communication control unit 14 includes a communication availability determination unit 15, an antenna control unit 16 (communication section control unit), and a guide information transmitting unit 17. In the storage section 90, tag type information 91 and an induced electromotive force table 92 are stored. These components will be described in detail below.

FIG. 4 is a diagram illustrating the positional relationship between the NFC antenna 60 and the touch panel 50 in the mobile terminal 1. As illustrated in FIG. 4, the NFC antenna 60 is disposed at a position overlapping the touch panel 50.

In this embodiment, the NFC antenna 60 is disposed at a position near the center of the touch panel 50. In a case that the user of the mobile terminal 1 establishes Near Field Communication between the mobile terminal 1 and the NFC tag 160, the user brings the NFC tag 160 in contact with or in proximity to the touch panel 50 at a position near the center of the touch panel 50 (a position on the touch panel 50 at which the NFC antenna 60 is provided) so that the NFC tag 160 and the NFC antenna 60 are brought in proximity to one another.

In the following, the embodiment will be described through an example in which Near Field Communication is established with the NFC tag 160 being in contact with the touch panel 50. However, such Near Field Communication may be established with the NFC tag 160 being in proximity to the touch panel 50.

As described below, operations of the NFC antenna 60 are controlled by the antenna control unit 16 (described below in detail). The NFC antenna 60 is controlled by the antenna control unit 16, so that the NFC antenna 60 is able to emit, toward the NFC tag 160, a radio signal which has a sufficient intensity for establishing Near Field Communication with the NFC tag 160. The upper limit of the intensity of the radio signal emitted from the NFC antenna 60 is predetermined in accordance with the specification of the NFC antenna 60.

The sensing unit 51 senses a position on the touch panel 50 at which the NFC tag 160 touches. The sensing unit 51 supplies position information indicating the sensed position of the NFC tag 160 to the tag position and shape identifying unit 11.

The sensing unit 51 also supplies the distribution of capacitance formed on the touch panel 50 with contact of the NFC tag 160, to the tag position and shape identifying unit 11.

### Tag Position and Shape Identifying Unit 11

The tag position and shape identifying unit 11 obtains the position information and the capacitance distribution from the touch panel 50. Then, the tag position and shape identifying unit 11 identifies the shape of the NFC tag 160 in contact with the touch panel 50 based on the capacitance distribution.

Specifically, the tag position and shape identifying unit 11 analyzes the capacitance distribution (for example, by performing an appropriate correction calculation or the like), and identifies the shape of the NFC tag 160 based on the analysis result. The tag position and shape identifying unit 11 may newly identify the position of the NFC tag 160 based on the analysis result.

The tag position and shape identifying unit 11 creates tag position and shape identifying information indicating the position and shape of the NFC tag 160, and supplies the information to the tag type identifying unit 12.

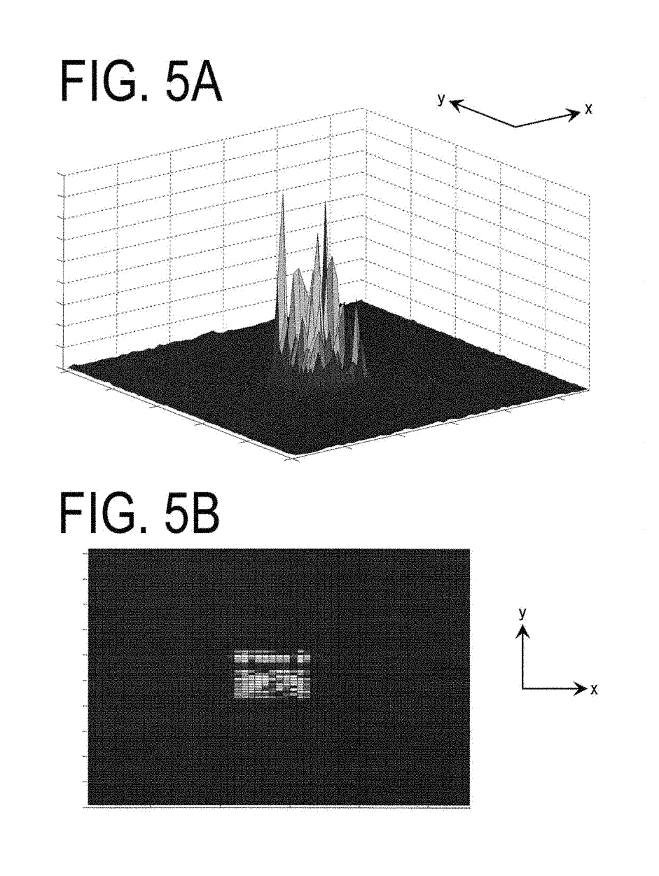

FIG. 5A is a perspective view and FIG, 5B is a top view, illustrating a graph representing, on an xy-plane, a distribution of capacitance formed on the touch panel 50 with contact of the NFC tag 160.

As illustrated in FIGS. 5A and 5B, the NFC tag 160 generally contains metal, so that the shape of the NFC tag 160 tends to be reflected in the capacitance distribution. For example, referring to FIG. 5B, it is understood that the shape (for example, a substantially rectangular shape) of the NFC tag 160 as well as the position of the NFC tag 160 in contact with the touch panel 50 is reflected in the capacitance distribution.

Thus, the tag position and shape identifying unit 11 is able to identify that the shape of the NFC tag 160 is substantially rectangular, for example, by analyzing the capacitance distribution in FIGS. 5A and 5B.

### Tag Type Identifying Unit 12

The tag type identifying unit 12 obtains (i) the tag position and shape identifying information, and (ii) the tag type information 91, from the tag position and shape identifying unit 11 and the storage section 90, respectively. The tag type information 91 is information indicating a type of the NFC tag used for the Near Field Communication with the mobile terminal 1.

In the tag type information 91, information indicating specifications of various types of NFC tags is associated with the types of the NFC tags. For example, the tag type information 91 contains information indicating (i) the shape of the NFC tag, (ii) a value of an induced electromotive force required for the Near Field Communication, and the like, for each NFC tag type.

Thus, the tag type identifying unit 12 is able to identify the type of the NFC tag 160 by checking (i) the shape of the NFC tag 160 indicated by the tag position and shape identifying information, against (ii) the shape of the NFC tag indicated in the tag type information 91. In other words, the tag type identifying unit 12 is able to identify the type of the NFC tag 160 based on the shape of the NFC tag 160.

Furthermore, the tag type identifying unit 12 creates tag type identifying information indicating the type of the NFC tag 160. The tag type identifying unit 12 supplies the created tag type identifying information to the induced electromotive force calculating unit 13 together with the above-described tag position and shape identifying information.

The types of the NFC tags available for Near Field Communication with the mobile terminal 1 are somewhat limited in accordance with the specification of the NFC antenna 60. For this reason, activation of the NFC antenna 60 may be prevented in a case that the tag type identifying unit 12 is not able to identify the type of the NFC tag 160.

In this way, even in a case that an NFC tag other than NFC tags of types pre-registered in the tag type information 91 (i.e., an NFC tag not available for Near Field Communication with the mobile terminal 1) is placed on the touch panel 50, the NFC antenna 60 is not activated. Accordingly, unnecessary activation of the NFC antenna 60 may be inhibited, which allows a reduction in the power consumption of the mobile terminal 1.

### Induced Electromotive Force Calculating Unit 13

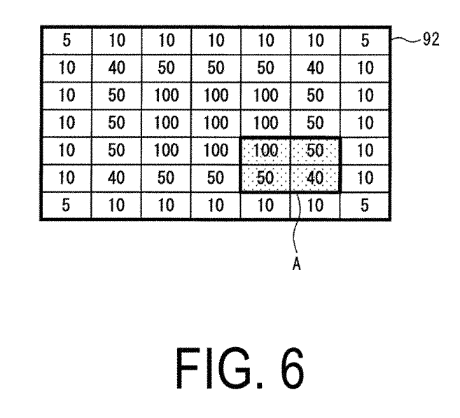

The induced electromotive force calculating unit 13 obtains (i) the tag type identifying information and (ii) the induced electromotive force table 92, from the tag type identifying unit 12 and the storage section 90, respectively. Before describing operations of the induced electromotive force calculating unit 13, the induced electromotive force table 92 will be described with reference to FIG. 6. FIG. 6 is a diagram illustrating one example of the induced electromotive force table 92.

The induced electromotive force table 92 serves as a look-up table indicating induced electromotive force generated at different positions of the NFC antenna 60 in a case that the NFC tag 160 is moved toward the antenna 60 while maintaining the face of the NFC antenna 60 parallel to the face of the NFC tag 160.

Cells in the induced electromotive force table 92 are associated with respective positions of the NFC antenna 60. Specifically, the cells in the induced electromotive force table 92 are associated with respective micro areas (blocks) into which the face of the NFC antenna 60 is divided.

For example, referring to FIG. 6, “100” that is the greatest induced electromotive force value is assigned to the cell corresponding to a position near the center of the induced electromotive force table 92. Thus, it is understood that the greatest induced electromotive force is generated near the center of the NFC antenna 60.

The induced electromotive force table 92 may be prepared based on experimental data relating to changes in magnetic field generated at the different blocks of the NFC antenna 60 when the Near Field Communication is established while moving the NFC tag 160 along the NFC antenna 60 with the distance between the face of the NFC antenna 60 and the face NFC tag 160, which are parallel to each other, maintained constant.

Specifically, an induced electromotive force generated at each block of the NFC antenna 60 may be calculated from the experimental data relating to changes in magnetic field based on the above-described Expression 1. Then, the induced electromotive force generated at each block is discretized (encoded), and the induced electromotive force table 92 is prepared.

In a case that the types of the NFC tags are not the same, the NFC tags which are different in type may also be different in coil shape. Thus, the NFC tags which are different in type may be different in the number of turns N and in variation in magnetic flux Δφ in the above-described Expression 1.

For this reason, the induced electromotive force table 92 is prepared for each type of the NFC tag. Therefore, the induced electromotive force calculating unit 13 is able to obtain the induced electromotive force table 92, which corresponds to the type of the NFC tag 160 indicated in the tag type identifying information, from the storage section 90.

Furthermore, based on the obtained induced electromotive force table 92, the induced electromotive force calculating unit 13 is able to calculate a value of an induced electromotive force to be generated in the NFC tag 160 to establish Near Field. Communication with the NFC antenna 60 at a current position of the NFC tag 160 (i.e., a position on the touch panel 50 at which contact of the NFC tag 160 is detected).

For example, consider the value of an induced electromotive force to be generated at a region A in the induced electromotive force table 92 with reference to FIG. 6. The region A contains four cells, and the values of induced electromotive force assigned to the respective cells are 100”, “50”, “50”, and “40”.

In this case, the induced electromotive force calculating unit 13 calculates the sum of the induced electromotive force values assigned to the respective cells in the region A as a value of an induced electromotive force to be generated at the region A. Specifically, the induced electromotive force calculating unit 13 calculates the value of an induced electromotive force to be generated at the region A as follows: 100+50+50+40=240.

The region A may be defined by the induced electromotive force calculating unit 13 so as to correspond to the position of the NFC tag 160 indicated by the tag position and shape identifying information. As such, the induced electromotive force calculating unit 13 is able to calculate the value of an induced electromotive force to establish Near Field Communication with the NFC antenna 60, based on the type of the NFC tag 160.

Specifically, the induced electromotive force calculating unit 13 is able to calculate the value of an induced electromotive force to be generated in the NFC tag 160 of a predetermined type to establish Near Field Communication with the NFC antenna 60 at a current position of the NFC tag 160. Furthermore, the induced electromotive force calculating unit 13 supplies the calculated induced electromotive force value to the communication availability determination unit 15.

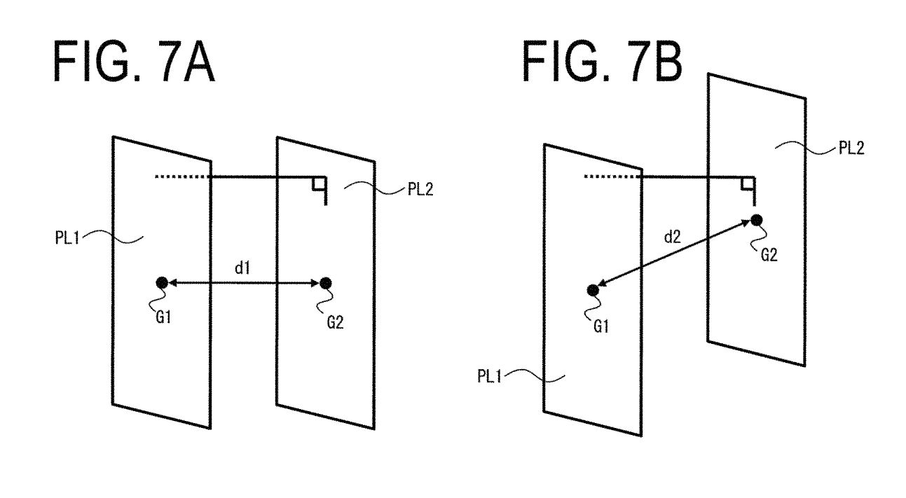

In the following, the reason that the induced electromotive force calculating unit 13 calculates the induced electromotive force by use of the above-described induced electromotive force table 92 will be described with reference to FIGS, 7A and 7B, FIG. 7A and FIG. 7B are diagrams each illustrating a distance between the center point G1 of a plane PL1 and the center point G2 of a plane PL2.

In FIGS, 7A and 7B, the plane PL1 and the plane PL2 are parallel to each other. By way of example, it may be understood that the plane PL 1 serves as a face of the NFC antenna 60 and the plane PL2 serves as a face of the NFC tag 160.

FIG. 7A illustrates an example in which a line segment linking the center point G1 and the center point G2 is orthogonal to the plane PL1 and the plane PL2. The length of the line segment (i.e., the distance between the center point G1 and the center point G2) in FIG. 7A is denoted as d1. The distance d1 is equal to the distance between the center point G1 and the center point G2.

FIG. 7B illustrate an example in which the plane PL2 is moved with the position of the plane PL1 kept unchanged. In FIG. 7B, a line segment linking the center point G1 and the center point (32 is not orthogonal to the plane PL1 and the plane PL2. The length of the line segment (i.e., the distance between the center point G1 and the center point G2) in FIG. 7B is denoted as d2.

The distance d2 is greater than the distance between the plane PL1 and the plane PL2 (i.e., the distance d1). Thus, it is understood that in a case that only one of the two parallel planes is moved, the distance between the points on the planes increases although the distance between the two planes is maintained constant.

Accordingly, in a case that the NFC tag 160 is moved along the NFC antenna 60 with the face of the NFC antenna 60 and the face of the NFC tag 160 kept in parallel, the distance between the NFC antenna 60 and the coil 162 increases although the distance between the face of the NFC antenna 60 and the face of the NFC tag 160 is maintained constant. As a result, the amount of magnetic flux interlinked with the coil 162 reduces.

Consequently, for theoretical calculation of the induced electromotive force by using Expression 1, not only the distance between the NFC antenna 60 and the coil 162 but also the distance between the face of the NFC antenna 60 and the face of the NFC tag 160 needs to be considered. However, the amount of change in the distance is not readily calculated.

Therefore, the induced electromotive force calculating unit 13 of the embodiment uses the above-described induced electromotive force table 92 to calculate the induced electromotive force. This configuration facilitates the calculation of the value of an induced electromotive force to be generated in the NFC tag 160 to establish Near Field Communication with the NFC antenna 60.

The touch panel 50 of a type able to sense a hovering operation is able to determine the distance between the faces of the touch panel 50 and the NFC tag 160. In this case, the induced electromotive force table 92 may be provided for each different distance between the face of the NFC antenna 60 and the face of the NFC tag 160. Providing such took-up tables makes it possible to calculate the above-described induced electromotive force value based on the distance between the face of the NFC antenna 60 and the face of the NFC tag 160.

### Components of Communication Control Unit 14

The communication control unit 14 comprehensively controls operations for Near Field Communication between the mobile terminal 1 and the NFC antenna 60. In the following, the components of the communication control unit 14 will be described.

The communication availability determination unit 15 obtains the above-described induced electromotive force value from the induced electromotive force calculating unit 13. The communication availability determination unit 15 determines whether the induced electromotive force value is obtained in a case that the intensity of a radio signal emitted from the NFC antenna 60 is changed.

That is, it may be understood that the communication availability determination unit 15 serves as a component for determining whether Near Field Communication between the NFC antenna 60 and the NFC tag 160 is possible at a current position of the NFC tag 160 in a case that NFC antenna 60 is activated.

In other words, it may be understood that the communication availability determination unit 15 serves as a component for determining whether the NFC tag 160 available for Near Field Communication with the NFC antenna 60 is in contact with the touch panel 50. The communication availability determination unit 15 creates determination result information indicating the result of the determination, and supplies the determination result information to the antenna control unit 16 and the guide information transmitting unit 17.

The antenna control unit 16 serves as a component for controlling operations of the NFC antenna 60. The antenna control unit 16 has (i) the function of activating or deactivating the NFC antenna 60, and (ii) the function of changing the intensity of a radio signal emitted from the NFC antenna 60.

More specifically, the antenna control unit 16 controls operations of the NFC antenna 60 based on the above-described determination result information. Specifically, the antenna control unit 16 activates the NFC antenna 60 in a case that the determination result information indicates that the current position of the NFC tag 160 is acceptable for establishing Near Field Communication between the NFC antenna 60 and the NFC tag 160.

Subsequently, the antenna control unit 16 increases the intensity of a radio signal from the NFC antenna 60 so that Near Field Communication with the NFC tag 160 is enabled. As a result, the radio signal emitted from the NFC antenna 60 enables an induced electromotive force, which is sufficient for establishing the Near Field Communication, to be generated in the coil 162. Thus, the Near Field Communication between the NFC antenna 60 and the NFC tag 160 is enabled.

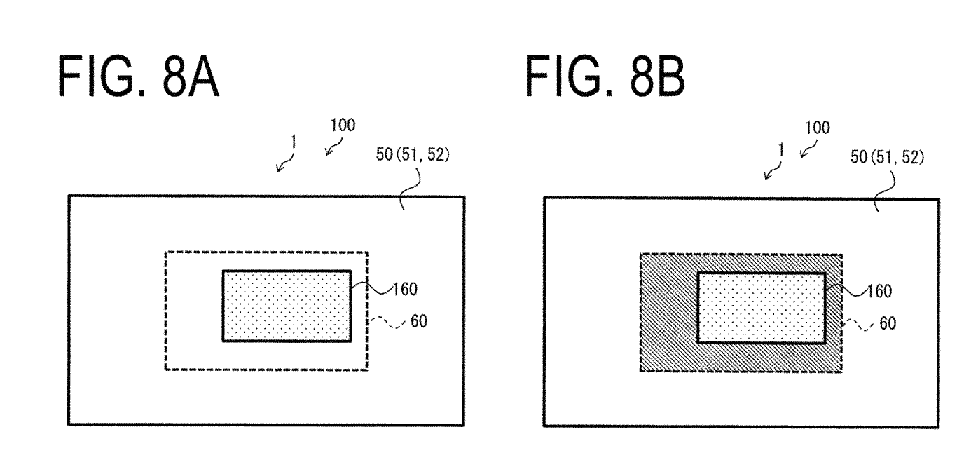

FIGS. 8A and 8B are diagrams each provided for explaining operations of the antenna control unit 16. FIG. 8A is a diagram illustrating a state just before the NFC antenna 60 is activated by the antenna control unit 16.

As illustrated in FIG. 8A, the NFC antenna 60 remains inactive until the NFC is activated by the antenna control unit 16 after the mobile terminal 1 is turned on. Thus, no Near Field Communication is established between the NFC antenna 60 and the NFC tag 160 until the NFC antenna 60 is activated.

FIG. 8B is a diagram illustrating a state just after the NFC antenna 60 is activated by the antenna control unit 16. The activation of the NFC antenna 60 causes the region, at which the NFC antenna 60 overlapping the touch panel 50 is disposed, to serve as a region where Near Field Communication between the NFC antenna 60 and the NFC tag 160 is enabled (a communicatable region on the touch panel 50).

As illustrated in FIG. 8B, the NFC antenna 60 is disposed at the communicatable region on the touch panel 50, so that an increase in the intensity of a radio signal from the NFC antenna 60 enables Near Field Communication between the NFC antenna 60 and the NFC tag 160.

In a case that the Near Field Communication between the NFC antenna 60 and the NFC tag 160 is terminated, the antenna control unit 16 deactivates the NFC antenna 60.

In a case that the determination result information indicates that the NFC tag 160 in contact with the touch panel 50 at the current position is unable to establish Near Field Communication, the antenna control unit 16 does not activate the NFC antenna 60.

This configuration allows the antenna control unit 16 to control the NFC antenna 60 only in a case that Near Field Communication is established between the NFC antenna 60 and the NFC tag 160.

In other words, in a case that Near Field Communication is not established, the NFC antenna 60 may remain deactivated. Therefore, the possibility that a radio signal emitted from the NFC antenna 60 adversely affects the touch panel 50 as noise may be reduced.

In a case that the determination result information indicates that the NFC tag 160 in contact with the touch panel 50 at the current position is unable to establish Near Field Communication, the guide information transmitting unit 17 supplies guide information to the display unit 52 (informing unit).

As used herein, the guide information indicates that NFC tag 160 needs to be moved from the current position to establish Near Field Communication between the NFC antenna 60 and the NFC tag 160. This guide information may be pre-stored in the guide information transmitting unit 17. The guide information transmitting unit 17 may be further configured to obtain guide information stored in the storage section 90.

The display unit 52 displays the guide information supplied from the guide information transmitting unit 17. Displaying the guide information on the display unit 52 enables the user to visually recognize the guide information, which in turn allows the user to reliably establish Near Field Communication. The guide information in this embodiment may be any data able to be displayed on the display unit 52 (on the display face of the touch panel 50).

For example, as guide information, character data representing the following messages (sentences) may he used: “Unable to establish Close Proximity Wireless Communication”, “NFC Tag is Far from NFC Antenna”, “Move NFC Tag toward NFC Antenna”, or the like. In addition, image data representing an alarm mark or the like may be used as the guide information.

Meanwhile, in a case that a plurality of NFC tags are located in proximity to a single NIT antenna 60, interference is caused between these NFC tags, which prevents Near Field Communication between the NFC antenna 60 and the NFC tags from being properly established.

Even in such a case, the guide information may be displayed on the display unit 52. This configuration allows a user to more reliably establish Near Field Communication. In this configuration, from the guide information, the user is able to recognize that: (i) the only one NFC tag intended for Near Field Communication with the NFC antenna 60 needs to be moved closer to the NFC antenna 60; and (ii) NFC tags other than the intended NFC tag need to be moved sufficiently far from the NFC antenna 60.

The guide information according to one aspect of the invention is not necessarily limited to data able to be displayed on the display unit 52. In other words, a component to which the guide information is supplied from the guide information transmitting unit 17 is not necessarily limited to only the display unit 52.

More specifically, such a component to which the guide informing is supplied may he a component for informing the user of the guide information (informing unit). Other specific examples of the informing unit will be described in the following section “Third Embodiment”. The display unit 52 of the embodiment may be understood as one specific example of the informing unit.

### Processing Flow of Close Proximity Wireless Communication in Mobile Terminal 1

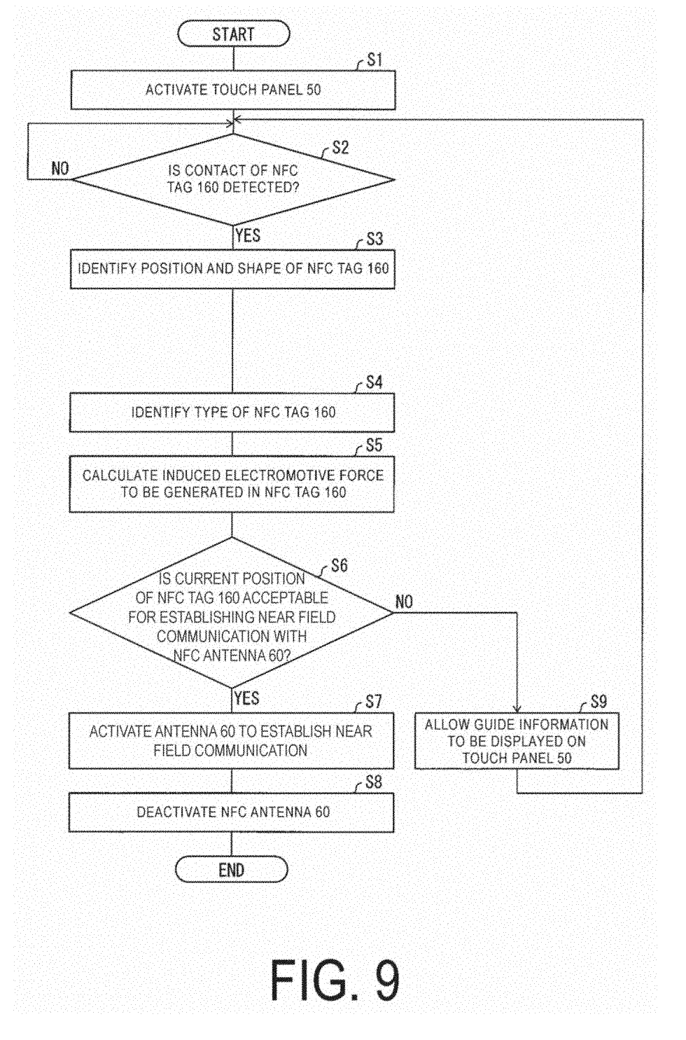

FIG. 9 is a flowchart illustrating an example of a flow of Near Field

Communication in the mobile terminal 1. In the following, the flow of Near Field Communication in the mobile terminal 1 will be described with reference to FIG. 9.

First, when the user turns on the mobile terminal 1, the mobile terminal 1 activates the touch panel 50 (step S1). Then, the sensing unit 51 senses whether the NFC tag 160 is in contact with the touch panel 50 (step S2).

In a case that the sensing unit 51 senses that the NFC tag 160 is in contact with the touch panel 50 (YES in step S2), the sensing unit 51 supplies, to the tag position and shape identifying unit 11, the distribution of the capacitance formed on the touch panel 50 with the contact of the NFC tag 160.

The tag position and shape identifying unit 11 identities the position and the shape of the NFC tag 160 based on the capacitance distribution based on the diameter analysis results (step S3). The tag position and shape identifying unit 11 creates tag position and shape identifying information indicating the position and shape of the NFC tag 160, and supplies the information to the tag type identifying unit 12.

In a case that the sensing unit 51 does not sense that the NFC tag 160 is in contact with the touch panel 50 (NO in step S2), the processing flow returns to step S2 described above. Then, the same process is repeated.

Subsequently, the tag type identifying unit 12 identifies the type of the NFC tag 160 based on the tag position and shape identifying information and the tag type information 91 (step S4). Furthermore, the tag type identifying unit 12 creates tag type identifying information indicating the type of the NFC tag 160. The tag type identifying unit 12 supplies the created tag type identifying information to the induced electromotive force calculating unit 13 together with the tag position and shape identifying information.

The induced electromotive force calculating unit 13 calculates the value of an induced electromotive force to be generated in the NFC tag 160 to establish Near Field. Communication between the NFC antenna 60 and the NFC tag 160 at the current position of the NFC tag 160, based on the tag position and shape identifying information, the tag type identifying information, and the induced electromotive force table 92 (step S5). Then, the induced electromotive force calculating unit 13 supplies the calculated induced electromotive force value to the communication availability determination unit 15.

The communication availability determination unit 15 determines whether the current position of the NFC tag 160 is acceptable for establishing Near Field Communication between the NFC antenna 60 and the NFC tag 160 based on the induced electromotive force value calculated by the communication availability determination unit 15 (step S6; communication availability determination step).

In other words, in step S6, the communication availability determination unit 15 determines whether the NFC tag 160 available for Near Field Communication with the NFC antenna 60 is in contact with the touch panel 50. Then, the communication availability determination unit 15 creates the determination result information indicating the result of the determination, and supplies the determination result information to the antenna control unit 16 and the guide information transmitting unit 17.

In a case that the NFC tag 160 available for Near Field Communication with the NFC antenna 60 is in contact with the touch panel 50 (YES in step S6), the antenna control unit 16 activates the NFC antenna 60 and increases the intensity of a radio signal from the NFC antenna 60. As a result, Near Field Communication between the NFC antenna 60 and the NFC tag 160 is enabled (step S7; communication control step),

In a case that the Near Field Communication between the NFC antenna 60 and the NFC tag 160 is terminated, the antenna control unit 16 deactivates the NFC antenna 60 (step S8).

In contrast, in a case that the NFC tag 160 in contact with the touch panel 50 at the current position is unable to establish Near Field Communication (NO in step S6), the guide information transmitting unit 17 supplies guide information to the display unit 52 and causes the display unit 52 to display the guide information (step S9). Then, the processing flow returns to step S2 described above.

### Effects of Information Processing System 100

As described above, in a capacitive touch panel, a process for sensing contact or proximity of an object is carried out based on the change in capacitance. Thus, operations of the capacitive touch panel are susceptible to the change in the surrounding electromagnetic field.

Therefore, in a case that the NFC antenna is constantly active, operations of the touch panel are affected by a radio signal (a magnetic field) emitted from the NFC antenna. That is, the radio signal emitted from the NFC antenna becomes noise to be constantly applied to the touch panel.

However, the information processing system 100 of the embodiment is able to activate the NFC antenna 60 to establish Near Field Communication only in a case that Near Field Communication between the NFC tag 160 and the NFC antenna 60 is enabled, which eliminates the need for the NFC antenna 60 to constantly emit a radio signal.

For this reason, the possibility that the radio signal emitted from the NFC antenna 60 adversely affects the touch panel 50 as noise is able to be particularly suitably reduced. As such, establishing Near Field Communication while using the touch panel 50 is made possible.

Furthermore, the use of the information processing system 100 of the embodiment eliminates the need to cause the NFC antenna 60 to constantly emit a radio signal, which allows the mobile terminal 1 to reduce its power consumption.

Furthermore, the use of the information processing system 100 of the embodiment allows the intensity of the radio signal emitted from the NFC antenna 60 to be controlled based on the type of the NFC tag 160, which allows Near Field Communication with various types of NFC tags.

Furthermore, the use of the information processing system 100 of the embodiment allows the intensity of the radio signal emitted from the NFC antenna 60 to be prevented from excessively increasing. This configuration allows an induced current to be prevented from excessively generating in the NFC tag 160.

Therefore, it is possible to prevent elements within the IC chip 161 from being damaged by the excessive induced current. In other words, the use of the information processing system 100 of the embodiment allows the NFC tag 160 to be prevented from being damaged.

Furthermore, the use of the information processing system 100 of the embodiment allows the intensity of the radio signal emitted from the NFC antenna 60 to be prevented from excessively increasing, which allows the touch panel 50 to be prevented from malfunctioning even in a case that the NFC antenna 60 is in operation.

### Modification

In a case that the intensity of the radio signal emitted from the NFC antenna 60 is sufficiently low enough that the touch panel 50 is not adversely affected, the NFC antenna 60 is allowed to he kept in operation while the touch panel 50 is in use. For example, the NFC antenna 60 may be allowed to perform polling by a radio signal of very low intensity.

In this case, the antenna control unit 16 has only to increase the intensity of a radio signal from the NFC antenna 60 to establish Near Field Communication with the NFC antenna 60 in a case that the NFC tag 160 available for establishing Near Field Communication is brought into contact with the touch panel 50.

For example, in a case that the mobile terminal 1 has a sufficient battery capacity, the NFC antenna 60 is also allowed to be kept in operation as described above. The constant operation of the NFC antenna 60 provides an advantage that a response time, until Near Field Communication with the NFC tag 160 is started after contact or proximity of the NFC tag 160 with respect to the touch panel 50 is detected, is able to be reduced.

Accordingly, it is understood that the antenna control unit according to one aspect of the invention has only to control operations of the NFC antenna 60 so that the NFC antenna 60 is brought into a state in which the NFC antenna 60 is enabled to establish Near Field Communication in a case that the NFC tag 160 available for Near Field Communication with the NFC antenna 60 is in contact with the touch panel 50.

Such a configuration of the antenna control unit as described above allows the NFC antenna 60 to establish Near Field Communication only in a case that Near Field Communication between the NFC tag 160 and the NFC antenna 60 is allowed, which eliminates the need for the NFC antenna 60 to constantly emit the radio signal of high intensity for establishing Near Field Communication.

For this reason, the possibility that the radio signal emitted from the NFC antenna 60 adversely affects the touch panel 50 is able to be reduced as in the first embodiment described above, so that it becomes possible to establish Near Field Communication while the touch panel 50 is in use.

### Second Embodiment

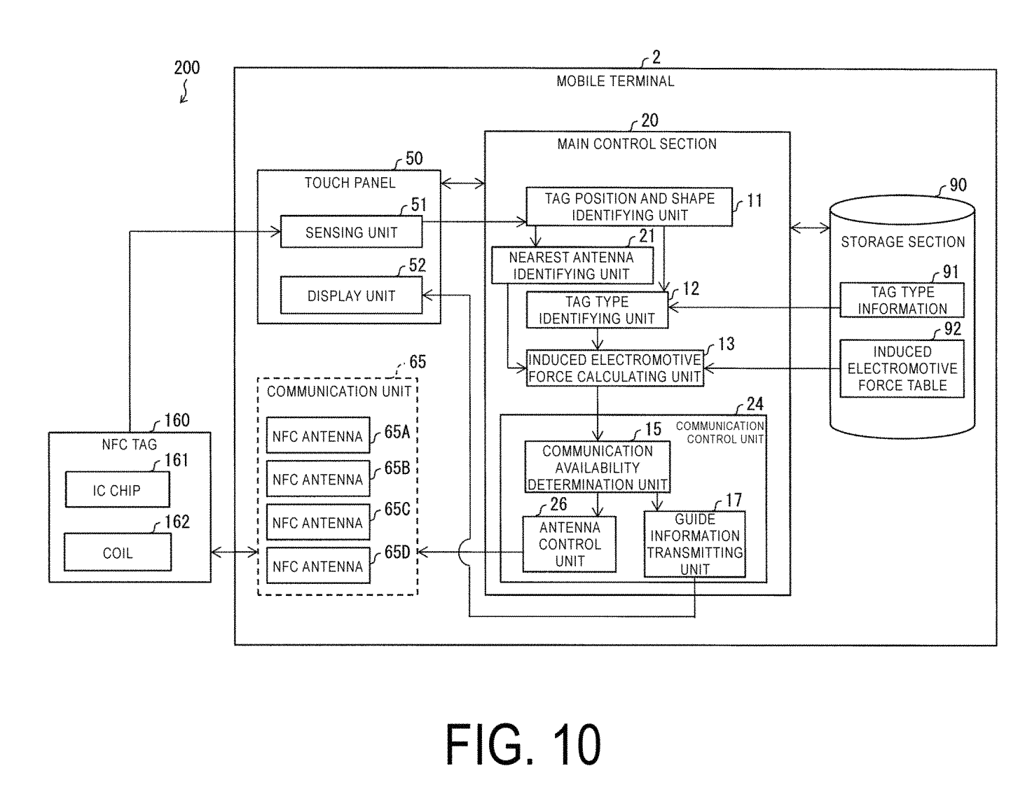

Another embodiment of the invention will be described with reference to FIGS. 10 to 12. For illustrative convenience, components having identical or similar functions as those described in the above-described embodiment arc designated by the same reference numerals as those of the above-described embodiment, and descriptions thereof are omitted.

### Information Processing System 200

FIG. 10 is a functional block diagram illustrating a configuration of essential components of an information processing system 200 according to the embodiment. As illustrated in FIG. 10, the information processing system 200 has a configuration in which the mobile terminal 1 of the first embodiment is replaced with a mobile terminal 2 (information processing device).

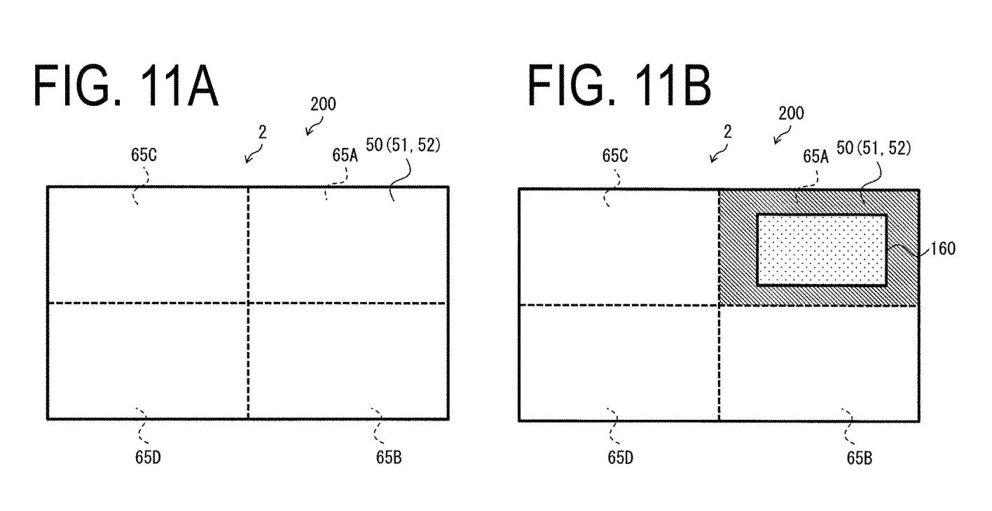

The mobile terminal 2 of the embodiment includes four NFC antennas 65A to 65D. FIG. 11A is a diagram illustrating the positional relationship between the NFC antennas 65A to 65D and the touch panel 50 in the mobile terminal 2.

As illustrated in FIG. 11, each of the NFC antennas 65A to 65D is disposed at a position overlapping the touch panel 50. More specifically, four NFC antennas 65A to 65D are disposed at four respective partial regions of the touch panel 50. These partial regions are regions defined by dividing the touch panel 50 in half along the X-axis direction and the Y-axis direction (see, for example, FIGS. 3A and 3B described above)

The mobile terminal 2 of the embodiment is different from the mobile terminal 1 of the first embodiment in that the mobile terminal 2 includes a plurality of NFC antennas. As illustrated in FIG. 10, the four NFC antennas 65A to 65D may be referred to collectively as “communication section 65”.

Furthermore, in the mobile terminal 2 of the embodiment, the main control section 10 of the first embodiment is replaced with the main control section 20 (control device) for controlling operations of the four NFC antennas 65A to 65D.

The main control section 20 is a component in which (i) a nearest antenna identifying unit 21 (identifying unit) is added and (ii) the antenna control unit 16 is replaced with an antenna control unit 26 (communication section control unit), with respect to the main control section 10 of the first embodiment. To distinguish from the first embodiment, the communication control unit of the second embodiment is referred to as “communication control unit 24”.

The nearest antenna identifying unit 21 obtains tag position and shape identifying information from the tag position and shape identifying unit 11. Furthermore, the nearest antenna identifying unit 21 identifies the NFC antenna located nearest the NFC tag 160 among the NFC antennas 65A to 65D based on the tag position and shape identifying information.

For example, in a case that the NFC tag 160 is disposed at a position illustrated in FIG. 11B (described below), the nearest antenna identifying unit 21 identifies the NFC antenna 65A as the NFC antenna located nearest the NFC tag 160.

Hereinafter, the NFC antenna located nearest the NFC tag 160 is referred to as “the nearest antenna”. The embodiment will be described through an example in which the NFC antenna 65A is the nearest antenna. It may be understood that the nearest antenna is an antenna that is especially suitable for Near Field Communication with the NFC tag 160 among the NFC antennas 65A to 65D.

The nearest antenna identifying unit 21 supplies information indicating the identified nearest antenna (the NFC antenna 65A) to the induced electromotive force calculating unit 13. After that, the individual components within the main control section 20 perform substantially the same processing steps as of the first embodiment described above.

For example, the induced electromotive force calculating unit 13 calculates the value of an induced electromotive force to be generated in the NFC tag 160 to establish Near Field Communication with the NFC antenna 65A. Furthermore, the information availability determination unit 15 determines whether the NFC tag 160 available for Near Field Communication with the NFC antenna region 65A is in contact with the touch panel 50.

Subsequently, in a case that the NFC tag 160 available for Near Communication with the NFC antenna 65A is in contact with the touch panel 50, the antenna control unit 26 activates the NFC antenna 65A to establish Near Field Communication with the NFC tag 160.

FIG. 11B is a diagram illustrating a state just after the NFC antenna 65A as the nearest antenna is activated by the antenna control unit 26. In this case, the NFC antennas other than the nearest antenna (i.e., the NFC antennas 65B to 65D) remain deactivated.

In other words, in the case of FIG. 11B, the region, at which the NFC antenna 65A overlaps the touch panel 50, is a communicatable region on the touch panel 50.

### Processing Flow of Close Proximity Wireless Communication in Mobile Terminal 2

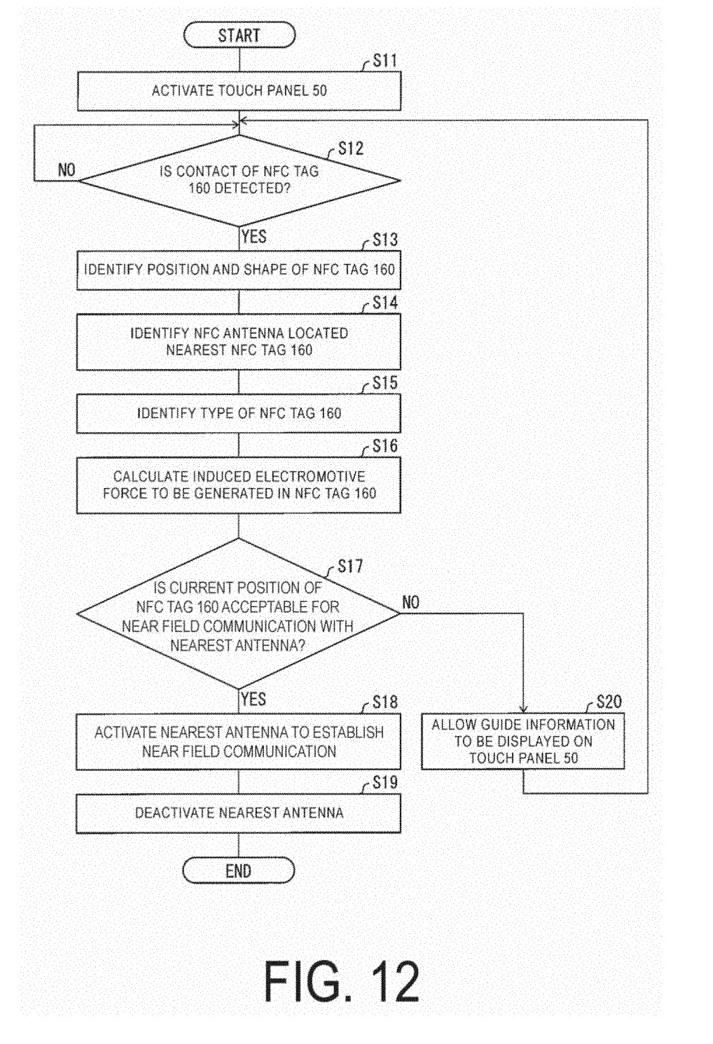

FIG. 12 is a flowchart illustrating an example of a flow from step S11 to step S20 of Near Field Communication in the mobile terminal 2. Steps S11 to S13, S15, and S20 in FIG. 12 are substantially the same as steps S1 to S3, S4, and S9; thus, descriptions of steps S11 to S13, S15, and S20 are omitted. In the following, step S14, steps S16 to S19, and processing associated with step S14 and steps S16 to S19 will be described with reference to FIG. 12.

After step S13, the nearest antenna identifying unit 21 identifies the NFC antenna located nearest the NFC tag 160 (i.e., the nearest antenna) among the NFC antennas 65A to 65D (step S14). Then, the process proceeds to step S15.

After step S15, the induced electromotive force calculating unit 13 calculates the value of an induced electromotive force to be generated in the NFC tag 160 to establish Near Field Communication with the nearest antenna (step S16).

Subsequently, the communication availability determination unit 25 determines whether the current position of the NFC tag 160 is acceptable for establishing Near Field Communication between the nearest antenna and the NFC tag 160 (step S17). In other words, in step S16, the communication availability determination unit 25 determines whether the NFC tag 160 available for Near Field Communication with the nearest antenna is in contact with the touch panel 50.

In a case that the NFC tag 160 available for Near Field Communication with the nearest antenna is in contact with the touch panel 50 (YES in step S17), the antenna control unit 26 activates the nearest antenna and increases the intensity of a radio signal from the nearest antenna. As a result, it becomes possible to establish Near Field Communication between the nearest antenna and the NFC tag 160 (step S18).

In a case that Near Field Communication between the nearest antenna and the NFC tag 160 is terminated, the antenna control unit 26 deactivates the nearest antenna (step S19).

### Effects of Information Processing System 200

According to the information processing system 200 of the embodiment, even in a case that a plurality of NFC antennas are provided, the nearest antenna that is an antenna located nearest the NFC tag 160 (in other words, an antenna especially suitable for Near Field Communication with the NFC tag 160) is able to be identified.

This configuration allows Near Field Communication to be established by activating a single nearest antenna without activating the plurality of NFC antennas at one time, which in turn allows a configuration for controlling operations of the plurality of NFC antennas to be simplified.

For example, the operations of the plurality of NFC antennas are able to be controlled by a relatively simple configuration in which switching circuits are provided between a control device for the single antenna and each of the plurality of NFC antennas.

Furthermore, the plurality of NFC antennas are not activated at one time, which prevents the occurrence of interference between the NFC antennas. Accordingly, this is an advantage that a component for preventing the interference between the plurality of NFC antennas (for example, an electromagnetic shield) need not be provided in the mobile terminal 2. This allows the structure of the mobile terminal 2 to be simplified.

In addition, in a case that the electromagnetic shield is provided in the mobile terminal 2, the radio signal is blocked by the electromagnetic shield, which generates a problem that Near Field Communication between the NFC tag and the nearest antenna may be inhibited. However, the use of the information processing system 200 of the embodiment eliminates the need to provide the electromagnetic shield in the mobile terminal 2. Thus, such a problem is able to be solved.

Furthermore, the plurality of NFC antennas are not activated at one time, so that the power consumption of the mobile terminal 2 is also able to be reduced. In addition, the possibility that the radio signals emitted from the plurality of NFC antennas adversely affect the touch panel 50 as noise is able to be reduced.

### Third Embodiment

In the third Embodiment described above, a configuration is exemplified in which the display unit 52 (the display face of the touch panel) is used as an informing unit for informing a user of the guide information. However, a component other than the display unit 52 may be used as the informing unit.

The informing unit may be a component provided inside the touch panel 50 or may be a component provided outside the touch panel 50. For example, a speaker (not illustrated, a component provided outside the touch panel 50) provided in the mobile terminal 1 may be used as the informing unit. In this case, the guide information supplied to the informing unit from the guide information transmitting unit 17 may be audio data corresponding to the above-described messages (sentences).

Then, the informing unit outputs the guide information supplied from the guide information transmitting unit 17, as an audio signal (a sound wave). The guide information is output from the informing unit as an audio signal, which allows the user to auditorily recognize the guide information. This configuration enables the user to more reliably establish Near Field Communication, as in the case in which the display unit 52 is used as the informing unit.

The informing unit may be a combination of the display unit 52 and the speaker. This configuration allows the user to visually and auditorily recognize the guide information, which in turn enables the user to more reliably establish Near Field Communication.

### Fourth Embodiment

In the embodiments described above, a mobile terminal, as a specific example of the information processing device according to one aspect of the invention, is described with examples. However, the information processing device according to one aspect of the invention is not limited to only the mobile terminal.

That is, the information processing device according to one aspect of the invention may be any device in which the communication section for establishing Near Field Communication with a terminal device is disposed at a position overlapping the touch panel. For example, even in a case that the communication section is disposed in the display device including a touch panel (an electronic black board, a signage, an information display, or the like), at a position overlapping the touch panel, the information processing device according to one aspect of the invention is able to be achieved.

### Modification

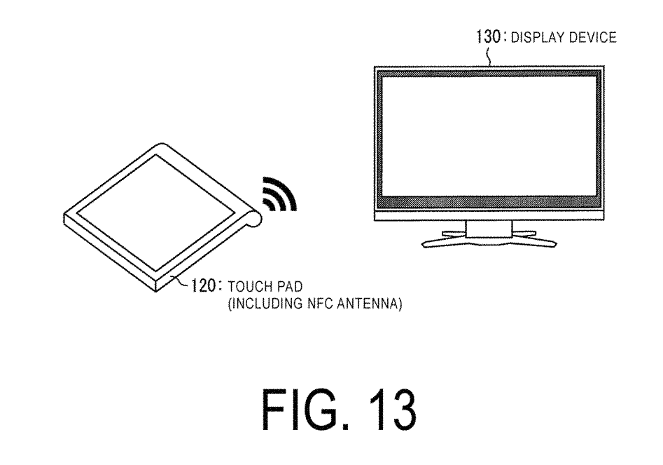

In the following, a modification of the invention will be described with reference to FIG. 13. FIG. 13 is a diagram illustrating the modification of the invention.

As described above, for the information processing device according to one aspect of the invention, the display unit 52 is not an essential component. That is, the information processing device according to one aspect of the invention may have no display device (display unit, display) as illustrated in FIG. 13. For example, the information processing device according to one aspect of the invention may be a touch pad 120 including an NFC antenna.

The touch pad 120 may be configured to be able to communicate with a display device 130. In this case, transmitting various types of image data from the touch pad 120 to the display device 130 allows such image data to be displayed on the display device 130.

As such, in a case that the display device 130 is placed remote from the touch pad 120 or even in a case that no NFC terminal is provided in the display device 130 as illustrated in FIG. 13, the above-described guide information is allowed to be displayed on the display device 130.

### Implementation Example by Software

The control blocks (in particular, the main control sections 10 and 20) of the mobile terminal 1 and 2 may be implemented by a logic circuit (hardware) formed in an integrated circuit (IC chip) and the like, or may be implemented by software using a Central Processing Unit (CPU).

In the latter case, the mobile terminal 1 and 2 each include a CPU for executing an instruction in a program that is software for implementing various functions, a Read Only Memory (ROM) or a storage device (which are referred to as “recording medium”) in which the program and various types of data are recorded in a computer-readable manner, a Random Access Memory (RAM) into which the above-described program is loaded. Then, the computer (or CPU) reads the program from the recording medium and executes the program to achieve the object of the invention. As the recording medium, a “non-transitory tangible medium”, such as a tape, a disk, a card, a semiconductor memory, or a programmable logic circuit, may be used. Further, the program may be supplied to the computer via any transmission medium (a communication network, a broadcast wave, or the like) able to transmit the program. Note that the invention may be implemented in a form of data signal embedded in a carrier wave, which is embodied by electronic transmission of the program.

### Summary

An information processing device (mobile terminal 1) according to the first aspect of the present invention includes: a touch panel (50) configured to sense contact or proximity of a terminal device (an NFC tag 160), a communication section (an NFC antenna 60) disposed at a position overlapping the touch panel and configured to establish Near Field Communication with the terminal device, a communication availability determination unit (15) configured to determine whether the terminal device able to establish Near Field Communication is in contact with or in proximity to the touch panel, and a communication section control unit (antenna control unit 16) configured to bring the communication section into a state where the communication section is able to establish Near Field Communication in a case that the communication availability determination unit determines that the terminal device is in contact with or in proximity to the touch panel.

According to the above-described configuration, the communication section is brought into the state where the communication section is able to establish Near Field Communication, only in a case that the terminal device able to establish Near Field Communication with the communication section is in contact with or in proximity to the touch panel (i.e., in a case that Near Field Communication between the terminal device and the communication section is allowed).

That is, it is possible to cause the communication section to establish Near Field Communication only in a case that Near Field Communication between the terminal device and the communication section is allowed, which eliminates the need for the communication section to constantly emit the radio signal of high intensity for establishing Near Field Communication.

For this reason, the possibility that the radio signal emitted from the communication section adversely affects the touch panel as a noise with respect to the touch panel is able to be reduced. As such, an advantageous effect is produced that establishing Near Field Communication is allowed while the touch panel is in use.

Preferably, an information processing device according to the second aspect of the invention corresponds to the information processing device according to the first aspect and further includes an informing unit (for example, display unit 52). In such an information processing device, in a case that the touch panel senses a position where the terminal device is brought into contact with or into proximity to the touch panel, and the communication availability determination unit determines that the terminal device in contact with or in proximity to the touch panel at a current position is unable to establish Near Field Communication, the informing unit informs a user of a guide information indicating the terminal device needs to be moved to establish Near Field Communication.

According to the above-described configuration, an advantageous effect is produced which allows the user to more reliably establish Near Field Communication. The informing unit may be a component provided inside the touch panel or may be a component provided outside the touch panel.

Preferably, an information processing device according to the third aspect of the invention corresponds to the information processing device according to the second aspect, in which the informing unit is a display face (display unit 52) of the touch panel.

According to the above-described configuration, the guide information is allowed to be displayed on the display face of the touch panel, which produces an advantageous effect allowing the user to visually recognize the guide information. The display unit may be a component provided integrally with a sense face of the touch panel or may be a component provided outside the touch panel.

Preferably, an information processing device according to the fourth aspect of the invention corresponds to the information processing device according to any one of the first aspect to the third aspect and further includes an identifying unit. In such an information processing device, the touch panel senses a position where the terminal device is brought into contact with or into proximity to the touch panel, a plurality of the communication sections (the NFC antennas 65A to 65D) are disposed, the identifying unit (the nearest antenna identifying unit 21) identifies a communication section located nearest the terminal device among the plurality of communication sections, and the communication section control unit brings the communication section identified by the identifying unit into a state where the communication section is able to establish Near Field Communication.

According to the above-described configuration, even in a case that the plurality of communication sections are provided, the communication section located nearest the terminal device (i.e., the antenna most suitable for Near Field Communication), and only this identifying unit may be brought into a state where the identifying unit is able to establish Near Field Communication.

Accordingly, an advantageous effect is produced which enables operations of the communication section to be readily controlled even in a case that the plurality of communication sections are provided.

Preferably, an information processing device according to the fifth aspect of the invention corresponds to the information processing device according t o any one of the first aspect to the fourth aspect and further includes an induced electromotive force calculating unit. In such an information processing device, the touch panel senses a position where the terminal device is brought into contact with or into proximity to the touch panel, the induced electromotive force calculating unit (13) calculates a value of an induced electromotive force to be generated in the terminal device to establish Near Field Communication with the communication section at the position where the terminal device is brought into contact with or into proximity to the touch panel, and the communication availability determination unit determines whether establishing Near Field Communication is allowed based on the induced electromotive force value.

According to the above-described configuration, an advantageous effect is produced which allows a determination whether Near Field Communication is allowed based on the calculated value of an induced electromotive force to be generated in the terminal device.

Preferably, an information processing device according to the sixth aspect of the invention corresponds to the information processing device according to the fifth aspect and further includes a type identifying unit configured to identify a type of the terminal device (tag type identifying Unit 12). In such an information processing device, the induced electromotive force calculating unit calculates the induced electromotive force value based on the type of the terminal device.

According to the above-described configuration, an advantageous effect is produced which allows Near Field Communication to be established based on the tag type, because the induced electromotive force value is able to be calculated based on the tag type.

Preferably, an information processing device according to the seventh aspect of the invention corresponds to the information processing device according to the sixth aspect and further includes a shape identifying unit (tag position and shape identifying unit 11) configured to identify the shape of the terminal device. In such an information processing device, the type identifying unit identifies the type of the terminal device based on the shape of the terminal device.

According to the above-described configuration, an advantageous effect is produced which allows the type of the terminal device to be identified based on the shape of the terminal device.

Preferably, an information processing device according to the eighth aspect of the invention corresponds to the information processing device according to any one of the first aspect to the seventh aspect. In such an information processing device, the communication section control unit activates the communication section in a deactivated state in a case that the communication availability determination unit determines that the terminal device is in contact with or in proximity to the touch panel.

According to the above-described configuration, the communication section may remain deactivated except in a case that Near Field Communication is established. Accordingly, an advantageous effect is produced which allows the possibility that the radio signal emitted from the communication section adversely affects the touch panel to particularly reduced.

A control method for controlling an information processing device according to the ninth aspect of the invention, the information processing device including a touch panel configured to sense contact or proximity of a terminal device, and a communication section disposed at a position overlapping the touch panel and configured to establish Near Field Communication with the terminal device, the method includes a communication availability determination step for determining whether the terminal device able to establish Near Field Communication with the communication section is in contact with or in proximity to the touch panel, and a communication section control step for bringing the communication section into a state Where the communication section is able to establish Near Field Communication in a case that the terminal device is determined to he in contact with or in proximity to the touch panel in the communication availability determination step.

According to the above-described configuration, an advantage effect similar to that of the information processing device according to one aspect of the invention is produced.

A control device according to the tenth aspect of the invention corresponds to a control device (a main control section 10) of an information processing device including a touch panel configured to sense contact or proximity of a terminal device, and a communication section disposed at a position overlapping the touch panel and configured to establish Near Field Communication with the terminal device. The control device includes: a communication availability determination unit configured to determine whether the terminal device able to establish Near Field Communication with the communication unit is in contact with or in proximity to the touch panel, and a communication section control unit configured to bring the communication section into a state where the communication section is able to establish Near Field Communication in a case that the communication availability determination unit determines that the terminal device is in contact with or in proximity with the touch panel.

According to the above-described configuration, an advantage effect similar to that of the information processing device according to one aspect of the invention is produced.

The information processing device according to each aspect of the invention may be implemented by a computer. In this case, a control program of the information processing device which causes the information processing device to be implemented by the computer functioning as the individual components (software elements) of the information processing device; and a computer-readable recording medium in which the control program is recorded, fall within the scope of the invention.

### Additional Notes

The present invention is not limited to each of the above-described embodiments. It is possible to make various modifications within the scope of the claims. An embodiment obtained by appropriately combining technical elements each disclosed in different embodiments falls also within the technical scope of the invention. Furthermore, technical elements disclosed in the respective embodiments may be combined to provide a new technical feature.

### INDUSTRIAL APPLICABILITY

The present invention can be applied to an information processing device.

### REFERENCE SIGNS LIST

1, 2 Mobile terminal (information processing device)

10, 20 Main control section (control device)

11 Tag position and shape identifying unit (shape identifying unit)

12 Tag type identifying unit (type identifying unit)

13 induced electromotive force calculating unit

15 Communication availability determination unit

16, 26 Antenna control unit (communication section control

21 Nearest antenna identifying unit (identifying unit)

50 Touch panel

52 Display unit (display face, informing unit)

60, 65A to 65D NFC antenna (communication section)

65 Communication unit

100, 200 Information processing system

160 NFC tag (terminal device)

1. An information processing device comprising:
a touch panel configured to sense contact or proximity of a terminal device;
a communication section disposed at a position overlapping the touch panel and configured to establish Near Field Communication with the terminal device;
a communication availability determination unit configured to determine whether the terminal device able to establish Near Field Communication with the communication section is in contact with or in proximity to the touch panel; and
a communication section control unit configured to bring the communication section into a state where the communication section is able to establish Near Field Communication in a case that the communication availability determination unit determines that the terminal device is in contact with or in proximity to the touch panel.

2. The information processing device according to claim 1, further comprising an informing unit,
wherein in a case that the touch panel senses a position where the terminal device is brought into contact with or into proximity to the touch panel, and the communication availability determination unit determines that the terminal device in contact with or in proximity to the touch panel at a current position is unable to establish Near Field Communication, the informing unit informs a user of a guide information indicating the terminal device needs to be moved to establish Near Field Communication.

3. The information processing device according to claim 2,
wherein the informing unit is a display face of the touch panel.

4. The information processing device according to claim 1, further comprising an identifying unit,
wherein the touch panel senses a position there the terminal device is brought into contact with or into proximity to the touch panel,
a plurality of the communication sections are disposed,
the identifying unit identifies a communication section located nearest the terminal device among the plurality of communication sections, and
the communication section control unit brings the communication section identified by the identifying unit into a state where the communication section is able to establish Near Field Communication.

5. The information processing device according to claim 1, further comprising an induced electromotive force calculating unit,
wherein the touch panel senses a position where the terminal device is brought into contact with or into proximity to the touch panel,
the induced electromotive force calculating unit calculates a value of an induced electromotive force to be generated in the terminal device to establish Near Field Communication with the communication section at the position where the terminal device is brought into contact with or into proximity to the touch panel, and
the communication availability determination unit determines whether establishing Near Field Communication is allowed based on the value of the induced electromotive force.

6. The information processing device according to claim 5, further comprising a type identifying unit configured to identify a type of the terminal device,
wherein the induced electromotive force calculating unit calculates the induced electromotive force based on the type of the terminal device.

7. The information processing device according to claim 6, further comprising a shape identifying unit configured to identify a shape of the terminal device,
wherein the type identifying unit identifies the type of the terminal device based on the shape of the terminal device.

8. The information processing device according to claim 1,
wherein the communication section control unit activates the communication section in a deactivated state in a case that the communication availability determination unit determines that the terminal device is in contact with or in proximity to the touch panel.

9. A control method for controlling an information processing device including a touch panel configured to sense contact or proximity of a terminal device, and a communication section disposed at a position overlapping the touch panel and configured to establish Near Field Communication with the terminal device, the method comprising:
a communication availability determination step for determining whether the terminal device able to establish Near Field Communication with the communication section is in contact with or in proximity to the touch panel; and
a communication section control step for bringing the communication section into a state the communication section is able to establish Near Field Communication a case that the terminal device is determined to be in contact with or in proximity to the touch panel in the communication availability determination step.

10. An control device of an information processing device including a touch panel configured to sense contact or proximity of a terminal device, and a communication section disposed at a position overlapping the touch panel and configured to establish Near Field Communication with the terminal device, the control device comprising:
a communication availability determination unit configured to determine whether the terminal device able to establish Near Field Communication with the communication section is in contact with or in proximity to the touch panel; and
a communication section control unit configured to bring the communication section into a state where the communication section is able to establish Near Field Communication in a case that the communication availability determination unit determines that the terminal device is in contact with or in proximity to the touch panel.

11. (canceled)
